(19) United States
(12) Patent Application Publication
(10) Pub. No.: US 2010/0215983 A1
(43) Pub. Date: Aug. 26, 2010

(54) Brazed Claddings for Cast Iron Substrates

(75) Inventors: Vaishalibahen Bhagwanbhai Patel, Louisville, KY (US); James Aaron Faust, New Albany, IN (US)

Correspondence Address: KENNAMETAL INC.;Intellectual Property Department, P.O. BOX 231, 1600 TECHNOLOGY WAY, LATROBE, PA, 15650, US

(73) Assignee: Kennametal Inc., Latrobe, PA (US)

(21) Appl. No.: 12/389,884

(22) Filed: Feb. 20, 2009

(51) Int. Cl. B32B 15/01; B23K 31/02; B23K 1/20; B22F 1/00

(52) U.S. Cl. 428/679; 228/246; 228/220; 228/205; 75/255

(57) ABSTRACT

The present invention discloses abrasion resistant claddings for cast iron substrates comprising hard particles and nickel-based braze alloys. The cladding material can be brazed on cast iron substrates at lower temperatures than conventional cladding materials, providing highly increased abrasion resistance to the cast iron substrate materials without adversely affecting the physical properties and structural integrity of such substrates.

### FIELD OF THE INVENTION

The present invention relates to claddings for cast iron substrates, and more particularly relates to wear resistant claddings comprising hard particles and Ni-based braze material for cast iron substrates. The present invention also relates to methods of bonding such claddings on cast iron substrates, and the materials used to form such claddings.

### BACKGROUND INFORMATION

Cast iron is useful for many applications, but does not have high levels of wear resistance. One approach to increase the wear resistance of cast iron components is to provide a hard cladding layer on the surface of the component. One type of cladding process is based upon vacuum furnace brazing at relatively high temperatures, e.g., above 2,000° F. However, many types of cast iron cannot withstand such high temperatures. In order to provide claddings on relatively low-melting cast iron parts, and to minimize substrate distortion, it would be desirable to provide a cladding that can be furnace brazed at lower temperatures, e.g., below 1,900° F.

### SUMMARY OF THE INVENTION

The present invention provides abrasion resistant claddings for cast iron substrates comprising hard particles and nickel-based braze alloys. The cladding material can be brazed on cast iron substrates at lower temperatures than conventional cladding materials, providing highly increased abrasion resistance to the cast iron substrate materials without adversely affecting the physical properties and structural integrity of such substrates.

An aspect of the present invention is to provide an article comprising a cast iron substrate, and a brazed cladding covering at least a portion of the cast iron substrate, wherein the brazed cladding has a brazing temperature of less than 1,900° F. and comprises hard particles and a nickel-based braze alloy.

Another aspect of the present invention is to provide a method of cladding a cast iron substrate. The method comprises the steps of applying at least one layer of brazing material comprising hard particles and nickel-based braze alloy powder to a cast iron substrate, and heating the at least one layer of brazing material and the cast iron substrate to a brazing temperature of less than 1,900° F. to thereby melt the braze material and form a brazed cladding on the cast iron substrate.

A further aspect of the present invention is to provide a brazing material for a cast iron substrate comprising from 30 to 70 weight percent hard particles, and from 70 to 30 weight percent nickel-based braze alloy powder having a melting point below 1,700° F.

These and other aspects of the present invention will be more apparent from the following description.

### BRIEF DESCRIPTION OF THE DRAWINGS

FIGS. 1-8 are photographs of ductile cast iron substrates with cladding layers applied thereto.

FIGS. 9A and 9B are photographs of a cast iron impeller coverage with an abrasion resistant brazed cladding in accordance with an embodiment of the present invention.

FIGS. 10A and 10B are photographs of a cast iron impeller coverage with an abrasion resistant brazed cladding in accordance with another embodiment of the present invention.

FIG. 11 is a graph comparing the relatively low abrasion resistance of ductile cast iron and high chrome cast iron with brazed cladding materials in accordance with embodiments of the present invention.

### DETAILED DESCRIPTION OF PREFERRED EMBODIMENT

The present invention provides cladding layers comprising hard particles and Ni-based braze material that are applied to a cast iron substrate utilizing a flexible cloth, a slurry, or the like. In one embodiment, the hard particles and braze material are applied together in the same flexible cloth. In another embodiment, alternating layers of cloth separately containing either the hard particles or the braze alloy are used. The ductile cast iron substrate with the layer(s) of cloth containing the hard particles and Ni-based braze material is placed in an inert or reducing atmosphere furnace and then heated to a brazing temperature, i.e., above the liquidus temperature of the braze material. In accordance with the present invention, the Ni-based braze alloy has a relatively low melting point, which allows the brazing operation to be carried out at temperatures that do not adversely affect the cast iron substrate material. The braze alloy melts, infiltrates into the hard particle layer, and wets the substrate, forming an aggregate cladding of hard particles in a Ni-based matrix that is metallurgically bonded to the substrate.

The hard particles may comprise carbides, cemented carbides, nitrides, borides and/or carbonitrides. One preferred example of a suitable hard particle is cobalt cemented tungsten carbide particles. For example, the particles comprise between about 5 weight percent and about 20 weight percent cobalt and between about 80 weight percent and about 95 weight percent tungsten carbide. The cemented tungsten carbide particles have a size that typically ranges between about 2 micrometers and about 500 micrometers. Other examples of suitable cemented hard particles, in addition to cemented tungsten carbide, include one or more of cemented vanadium carbide, cemented niobium carbide, cemented chromium carbide, cemented titanium carbide, cemented tantalum carbide, cemented molybdenum carbide, cemented hafnium carbide, cemented silicon carbide and cemented boron carbide. Cemented oxides such as aluminum oxide, zirconium oxide and hafnium oxide may also be used as the hard particles.

The braze material comprises a nickel-based alloy having a relatively low melting point, e.g., below 1,800° F. or below 1,700° F. For example, the nickel-based braze alloy may have a melting point of 1,600 to 1,650° F. As used herein, the term “nickel-based” means an alloy comprising at least 50 weight percent nickel. The nickel-based braze alloy may include alloying additions of phosphorous, and may also include chromium alloying additions. In one embodiment, the nickel-based braze alloy comprises from 5 to 20 weight percent P, from 0 to 20 weight percent Cr, and the balance Ni. One embodiment, a nickel-based braze material of the present invention is a nickel-phosphorous braze alloy having the following composition: 11 weight percent P, and the remainder Ni and incidental impurities. Another embodiment of a nickel-based braze material of the present invention is a nickel-phosphorous-chromium braze alloy having the following composition: 10 weight percent P; 14 weight percent Cr; and the remainder Ni and incidental impurities.

The weight ratio of the hard particles to the nickel-based braze material typically ranges from 1:0.4 to 1:1.5. Preferably, the weight ratio is from 1:0.5 to 1:0.7.

The cladding material may further include organic binders such as polymeric agents in amounts up to 5 weight percent. One type of binder is polytetraflouroethylene that is sold by Dupont under the name Teflon. Other binders known to those skilled in the art may also be used.

In one embodiment of the invention, a non-woven cloth comprised of hard particles and an organic binder may be rolled to a predetermined thickness, forming a flexible cloth that maintains a uniform weight and readily conforms to the shape of the underlying substrate. The cloth is then cut to shape and applied to the substrate, e.g., with a low temperature adhesive such as described in U.S. Pat. No. 4,194,040. Another cloth containing the nickel-based braze alloy powder is then applied onto the layer of hard particle cloth. After the cloth layers are applied to the substrate, they are heated to a temperature above the liquidus of the braze material to effect the metallurgical bonding of the hard particles together and to the substrate. In accordance with the present invention, the brazing temperature is below 1,900° F., typically from 1,750 to 1,850° F. The molten braze alloy capilates down into the layer of hard particles and wets the substrate, forming an aggregate cladding of hard particles in a Ni-based matrix that is metallurgically bonded to the substrate.

In another embodiment of the invention, a single flexible cloth is made with a mixture of the hard particles and braze material and then applied to the substrate. Heating to a brazing temperature of the braze material, as described above, results in brazing of the hard particles together and to the substrate.

In a further embodiment, the hard particles and nickel-based braze alloy may be applied to the cast iron substrate in the form of a slurry. The slurry may comprise a liquid carrier such as water and the ratio of particulate solids to liquid is selected as known in the art.

The brazing temperatures can vary depending upon the properties of the braze material, but exemplary temperatures range between a lower limit of about 1,750° F. and an upper limit of about 1,900° F. For example, the brazing temperature may be from about 1,800° F. to about 1,850° F. It should also be appreciated that the heating process to effect the metallurgical bonding may include multiple steps.

The present brazed cladding materials are at least twice as abrasion resistant as the cast iron substrate, typically at least 3 to 5 times more abrasion resistant. Cast iron substrates typically have abrasion resistance factors of 20-30 (ASTM G65, 1000/adjusted volume loss). Typical abrasion resistance of the present cladding materials typically exceeds 50 ARF, and may range from 60 to 130 ARF or higher.

Brazed claddings of the present invention were formed on ductile cast iron substrate. Carbide cloth having the chemistry shown in Table 1 was used in all testing. The nickel alloy is a −325 mesh nickel base alloy powder comprising about 15 weight percent Cr, 15 weight percent Mo, 5.5 weight percent Fe, 3.5 weight percent W, 0.5 weight percent Co, 0.4 weight percent Mn, and the balance Ni and incidental impurities. Two different grades, ASTM A536 grade 65-45-12 and ASTM A536 grade 80-55-06, of ductile cast iron substrate were used.

TABLE 1
Carbide Cloth Chemistry

| Cloth Component | Weight % |
|---|---|
| −325 macro-crystalline WC | 67.5 |
| 2 to 5 micron WC | 16.9 |
| Nickel alloy | 14.9 |
| PTFE | 0.7 |

Two different types of braze alloy were used. Table 2 shows the chemistry, melting point and brazing range of each alloy A and B.

TABLE 2
Braze Alloy Chemistry, Melting Point and Brazing Range

| Braze Alloy | Chemistry (wt %) | Melting Point | Brazing Range |
|---|---|---|---|
| A | Ni—10P—14Cr | 1630° F. | 1800-2000° F. |
| B | Ni—11P | 1610° F. | 1700-2000° F. |

Different combinations of surface preparation method were used to promote the maximum wetting during actual brazing process and to minimize cladding defects. Braze wash and actual brazing temperatures were also varied to achieve the best cladding quality. The heating and cooling rate were the same for all braze wash cycles as well as brazing cycles. Parts were heated at 12° F. per minute to 1,560° F., and 3° F. per minute thereafter. Parts were rapidly cooled from the top end temperature to 250° F. Tables 3 and 4 show the processes used to prepare the substrate surface before applying the claddings comprising the A or B braze alloys, respectively.

TABLE 3
Carbide Cloth and Braze Alloy A

| | | | | | | | | | Ranking |
|---|---|---|---|---|---|---|---|---|---|
| | | | | | | | | | {results |
| | | | | | | | | | ranked from |
| | | | | | | | | | 1-10 based |
| | Surface Preparation Method | | | | | | | | on cladding |
| | | | | 0.010″-0.015″ | | | Braze | | bonding and |
| | Wash & | Vacuum | | Braze | | | Wash | | appearance |
| Test | Grit | Burn Off | Braze | Cloth | Grit | Ni | Temp | Brazing | (10 being the |
| No. | Blast | @ 1865° F. | Wash | Wash | Blast | Plating | ° F. | Temp ° F. | best)} |
| 1 | ✓ | X | X | X | X | X | NA | 1850 | 3 |
| 2 | ✓ | X | X | X | X | ✓ | NA | 1850 | 0 |
| 3 | ✓ | ✓ | X | X | ✓ | X | NA | 1850 | 6 |
| 4 | ✓ | ✓ | ✓ | X | ✓ | X | 1865 | 1850 | 7 |
| 5 | ✓ | ✓ | X | ✓ | ✓ | X | 1865 | 1850 | 7.5 |
| 6 | ✓ | X | ✓ | X | ✓ | X | 1865 | 1850 | 7 |
| 7 | ✓ | X | X | ✓ | ✓ | X | 1880 | 1850 | 9 |
| 8 | ✓ | X | ✓ | X | ✓ | X | 1880 | 1850 | 9 |
| 9 | ✓ | X | ✓ | X | ✓ | X | 1875 | 1840 | 9.5 |
| 10 | ✓ | X | ✓ | X | ✓ | X | 1875 | 1840 | 9.5 |

TABLE 4
Carbide Cloth and Braze Alloy B

| | Surface Preparation Method | | | | | | Rank results 1-10 |
|---|---|---|---|---|---|---|---|
| | | | 0.010″-0.015″ | | Braze | | based on cladding |
| | Wash | | Braze | | Wash | Brazing | bonding and |
| Test | & Grit | Braze | Cloth | Grit | Temp | Temp | appearance (10 being |
| No. | Blast | Wash | Wash | Blast | ° F. | ° F. | the best) |
| 11 | ✓ | x | ✓ | ✓ | 1875 | 1800 | 8.5 |
| 12 | ✓ | ✓ | x | ✓ | 1800 | 1760 | 10 |
| 13 | ✓ | ✓ | x | ✓ | 1800 | 1760 | 10 |

Wash & grit blast—parts were washed and grit blasted as per the wash and grit blast procedure.

Vacuum burn off—parts were heated in a vacuum furnace at controlled temperatures.

A braze wash—A braze wash applied on parts as per the braze wash procedure and parts were heated in a furnace at controlled temperatures.

B braze wash—B braze wash was applied on parts as per the braze wash procedure and parts were heated in a furnace at controlled temperatures.

Grit blast—parts were grit blasted as per the grit blast procedure.

Ni plating—parts were Ni plated using a standard electrolysis Ni plating process.

The coating application method was the same throughout the testing. The carbide cloth thickness was 0.06 inch. A 0.62 braze ratio was used with the A and B braze alloys. One cladded part of each test set was ground to visually check the porosity in the cladding.

After successful test results were obtained from Test Nos. 9, 10, 11 and 12, A and B cladding were applied on 6 inch ductile iron open impellers.

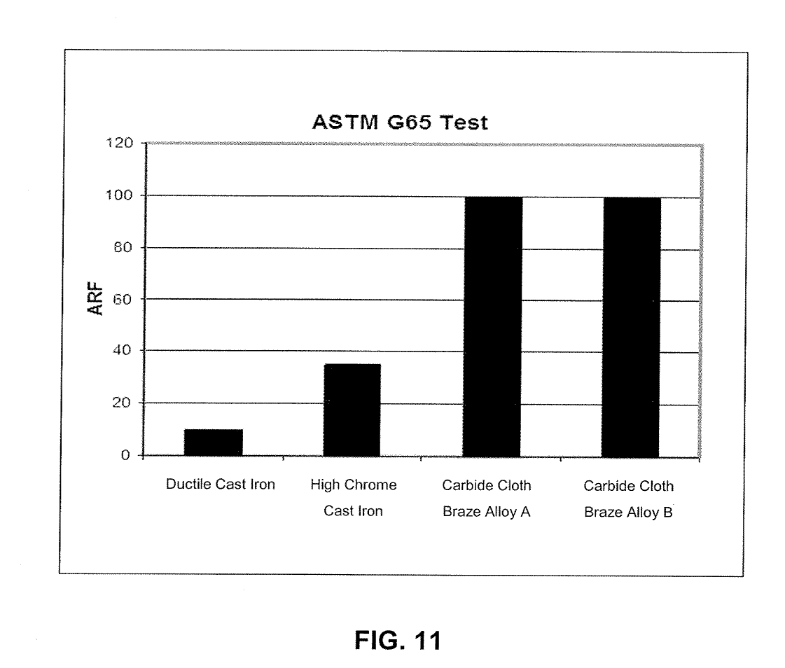

ASTM G65 test was performed on an ASTM A536 grade 65-45-12 ductile iron substrate and a high chrome cast iron substrate. The same test was also performed on the cladded coupons. Test results are shown in FIG. 11.

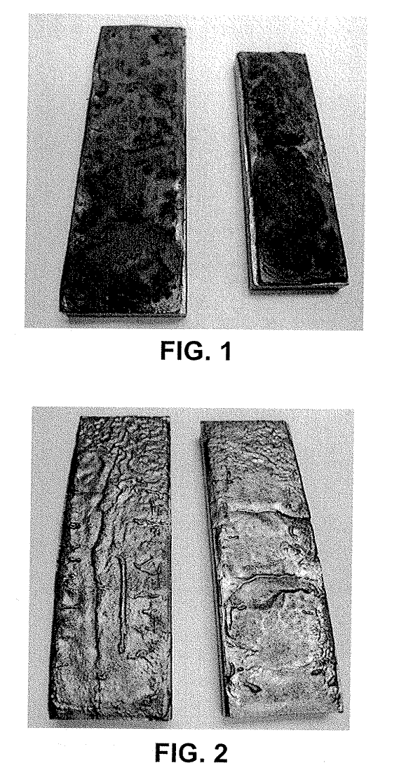

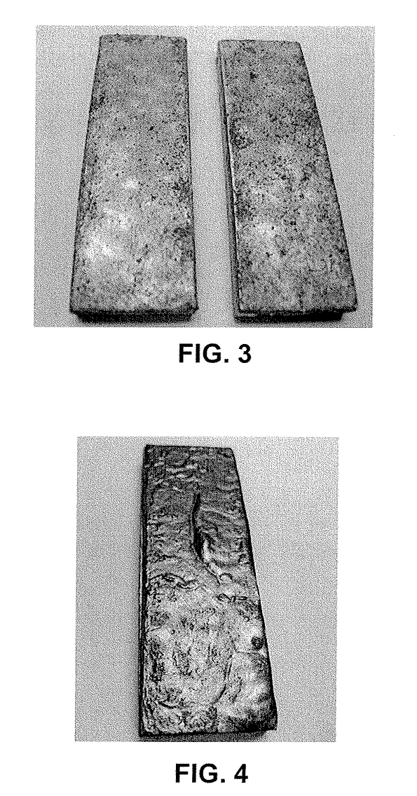

FIGS. 1, 2, 3, 4 and 5 show the cladded coupons in Test Nos. 2, 3, 6, 10 and 9, respectively. There was not good bonding between the substrate and the cladding in Test No. 1. Parts were Ni Plated in Test No. 2 before applying the actual cladding. Big bubbles were observed after cladding the parts, and there was no good bonding between the cladding and the substrate. The cladding had good bonding with the substrates in Test Nos. 3, 4, 5 and 6, however, wrinkles and valleys were observed on the coupons cladded in these tests. The intensity and percentage of total wrinkles per area and valleys were much higher in Test No. 3 than in Test Nos. 4, 5 and 6. The parts cladded in Test No. 6 are shown in FIG. 3. The visual appearance of the cladding in Test Nos. 4 and 6 were very similar.

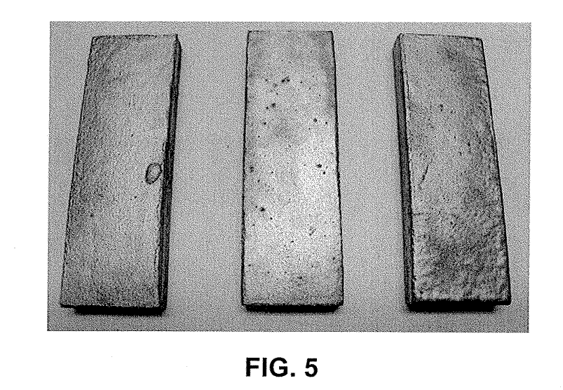

FIGS. 4 and 5 show the cladded parts in Test Nos. 10 and 9, respectively. There were no wrinkles or valleys observed in both tests. A minor bubble was observed in the cladding on one of the parts in Test No. 9. No bubbles were observed on the other two coupons clad in the same manner. Minor scales were observed on the cladding surface of the coupons in Test No. 10.

Braze alloy B was used in Test Nos. 1, 12 and 13. A braze cloth comprising a nickel alloy corresponding to braze alloy A was used in the braze wash process in Test No. 11. Test No. 13 was repeated with the same conditions used in Test No. 12 to check the repeatability.

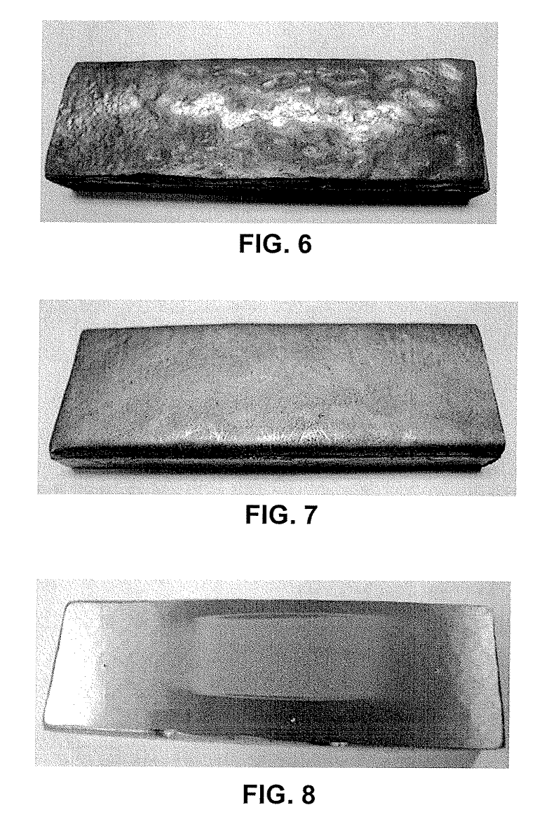

FIG. 6 shows the clad part in Test No. 11. There were no wrinkles, disbonding, bubbles or any other types of major defects observed in Test No. 11. However, the overall appearance of the cladding was not good because of discoloration and minor bumps in the cladding.

FIGS. 7 and 8 show the parts clad in Test No. 12. The cladding in FIG. 7 was not ground. FIG. 8 shows the same coupon after grinding. There was no porosity observed visually in the cladding after grinding.

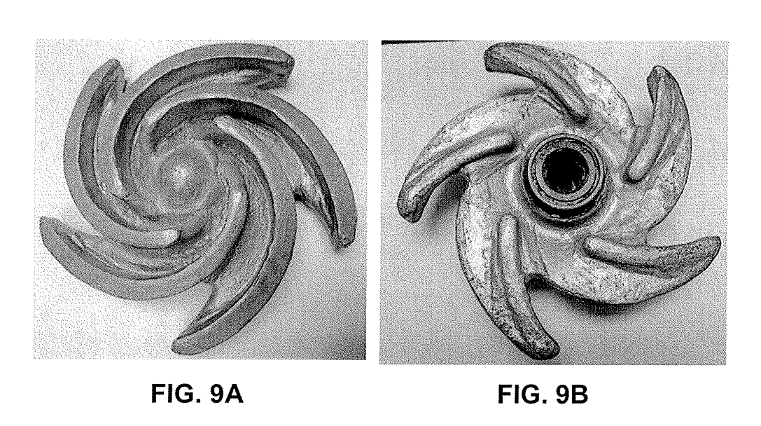

FIGS. 9A and 9B show the front and back of the 6 inch open impeller cladded using the carbide cloth and braze alloy A. The surface preparation method used before used before applying the carbide cloth was the same as the method used in Test Nos. 9 and 10. Minor scale was observed on the back of the impeller, but overall the cladding looked very good.

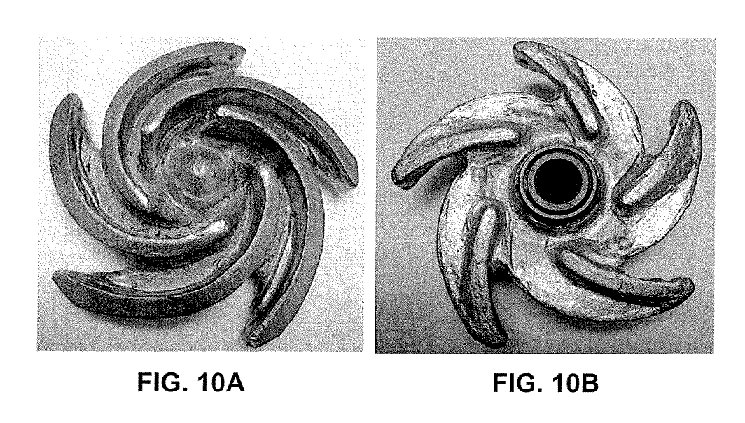

FIGS. 10A and 10B shows the front and back of the 6 inch open impeller cladded using the carbide cloth and braze alloy B. The surface preparation method used before applying the carbide cloth was the same as the method used in Test Nos. 12 and 13. No defects were observed in the cladding and the part looked very good.

FIG. 11 shows the ASTM G65 test results. The ARF abrasion resistance of the samples comprising either braze alloy A or B are almost the same. The ARF abrasion resistance of the cladding is approximately 9 to 10 times better than the bare cast iron substrate.

From the above test results, it is apparent that braze alloys A and B can be used to clad cast iron substrates. The surface of the cast iron is preferably cleaned as per the surface preparation method used for Test Nos. 9 and 10 for braze alloy A and Test Nos. 12 and 13 for braze alloy B, respectively.

The cladding layers of the present invention have been found to possess very high abrasion resistance. For example, abrasion resistance is typically above 50 ARF in accordance with the ASTM G65 Procedure A abrasion test, and may range from 60 to 120 ARF, or higher. Although the tests were performed on ductile cast iron substrates, the present claddings may also be used on other cast iron substrates.

Whereas particular embodiments of this invention have been described above for purposes of illustration, it will be evident to those skilled in the art that numerous variations of the details of the present invention may be made without departing from the invention as defined in the appended claims.

1. An article comprising:
a cast iron substrate; and
a brazed cladding covering at least a portion of the cast iron substrate, wherein the brazed cladding has a brazing temperature of less than 1,900° F. and comprises hard particles and a nickel-based braze alloy.

2. The article of claim 1, wherein the nickel-based braze alloy comprises phosphorous.

3. The article of claim 2, wherein the phosphorous comprises from 5 to 15 weight percent of the nickel-based braze alloy.

4. The article of claim 2, wherein the phosphorous comprises from 8 to 12 weight percent of the nickel-based braze alloy.

5. The article of claim 2, wherein the phosphorous comprises from 10 to 11 weight percent of the nickel-based braze alloy.

6. The article of claim 2, wherein the nickel-based braze alloy further comprises chromium.

7. The article of claim 6, wherein the chromium comprises from 8 to 20 weight percent of the nickel-based braze alloy.

8. The article of claim 6, wherein the chromium comprises from 12 to 16 weight percent of the nickel-based braze alloy.

9. The article of claim 6, wherein the chromium comprises about 14 weight percent of the nickel-based braze alloy.

10. The article of claim 1, wherein the nickel-based braze alloy comprises from 8 to 12 weight percent phosphorous, from 12 to 16 weight percent chromium, and the balance nickel and incidental impurities.

11. The article of claim 1, wherein the hard particles comprise tungsten carbide, cobalt bonded tungsten carbide, nickel bonded tungsten carbide, titanium carbide, tantalum carbide, zirconium niobium carbide, niobium carbide, titanium diboride, chromium carbide, silicone carbide, aluminum oxide, vanadium carbide, boron carbide and/or hafnium carbide.

12. The article of claim 1, wherein the hard particles comprise tungsten carbide and cobalt.

13. The article of claim 1, wherein the hard particles comprise −325 mesh tungsten carbide, 1 to 10 micron tungsten carbide, and 6 to 9 weight percent Co.

14. The article of claim 1, wherein the cast iron substrate has a melting temperature below 2,200° F.

15. The article of claim 1, wherein the cast iron substrate comprises ductile iron.

16. The article of claim 1, wherein the brazed cladding has a thickness of from 0.001 to 0.25 inch.

17. The article of claim 1, wherein the brazed cladding has a thickness of from 0.03 to 0.08 inch.

18. The article of claim 1, wherein the brazed cladding has an abrasion resistance of at least 50 ARF in accordance with the ASTM G65 Procedure A abrasion test (1000/AVL).

19. A method of cladding a cast iron substrate comprising:
applying at least one layer of a non-woven cloth comprised of a brazing alloy and hard particles to a cast iron substrate; and
heating at least one layer of brazing material and the cast iron substrate to a brazing temperature of less than 1,900° F. to thereby melt the braze material and form a brazed cladding on the cast iron substrate.

20. The method of claim 19, wherein at least one layer of brazing material is applied to the cast iron substrate with a cloth carrier material.

21. The method of claim 19, wherein the hard particles are applied in the form of a layer of non-woven cloth and the nickel-based braze alloy powder is separately applied in the form of a second layer of non-woven cloth.

22. The method of claim 19, wherein the at least one layer of brazing material is applied to the cast iron substrate in the form of a slurry.

23. The method of claim 19, wherein the brazing temperature is from 1,750 to 1,850° F.

24. The method of claim 19, wherein the heating step is performed in an inert atmosphere.

25. The method of claim 19, wherein the heating step is performed in vacuum from 1×10⁻³ to 1×10⁻⁷ torr.

26. The method of claim 19, wherein the cast iron substrate is cleaned by gritblasting method before the at least one layer of brazing material is applied.

27. A brazing material for a cast iron substrate comprising:
from 30 to 70 weight percent hard particles; and
from 70 to 30 weight percent nickel-based braze alloy powder having a melting point below 1,700° F.

28. The brazing material of claim 27, wherein the melting point of the nickel-based braze alloy powder is from 1,600 to 1,650° F.

29. The brazing material of claim 27, wherein the nickel-based braze alloy powder has an average particle size of from 1 to 500 microns.

30. The brazing material of claim 27, wherein the nickel-based braze alloy powder has an average particle size of from 20 to 120 microns.

31. The brazing material of claim 27, wherein the hard particles have an average particle size of from 1 to 500 microns.

32. The brazing material of claim 27, wherein the hard particles have an average particle size of from 1 to 50 microns.

33. The brazing material of claim 27, wherein the hard particles and the nickel-based braze alloy powder are are combined with an organic binder to form at least one layer of a non-woven cloth.
